(19) United States
(12) Patent Application Publication
(10) Pub. No.: US 2023/0113196 A1
(43) Pub. Date: Apr. 13, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shunya TAKEUCHI, Mie (JP); Akihiro NISHITANI, Mie (JP); Yutaka KOBAYASHI, Mie (JP)

(21) Appl. No.: 17/802,455

(22) PCT Filed: Feb. 15, 2021
(86) PCT No.: PCT/JP2021/005441

§ 371 Date: Aug. 25, 2022

(30) Foreign Application Priority Data
Mar. 6, 2020 (JP) 2020-038711

(51) Int. Cl. H01R 13/426; H01R 13/35

(52) U.S. Cl. CPC H01R 13/426; H01R 13/35

(57) ABSTRACT

-- A connector is provided with a movable conductive member (30) and a fixed conductive member (35) capable of electrically contacting a first conductor (42) and a second conductor (57) as connection objects, and a pressing member (25) made of a resilient insulating material and configured to apply a pressing force in a contact direction to the movable conductive member (30), the fixed conductive member (35), the first conductor (42) and the second conductor (57). The pressing member (25) includes a first pressing portion (26R) for applying a pressing force to the first conductor (42) and a second pressing portion (26F) for applying a pressing force to the second conductor (57). The first pressing portion (26R) and the second pressing portion (26F) are resiliently deformable independently of each other.

### TECHNICAL FIELD

The present disclosure relates to a connector.

### BACKGROUND

Patent Document 1 discloses a female terminal formed, such as by bending an electrically conductive metal plate. The female terminal includes a box-shaped electrical contact portion, into which a male terminal is inserted, in a front part and a pair of conductor crimping pieces in the form of an open barrel in a rear part. The conductor crimping pieces are crimped and fixed to a conductor exposed by stripping a coating of a coated wire.

Patent Document 2 discloses a female connector provided with a female terminal fitting, first and second obliquely wound coil springs and a female housing for holding the both obliquely wound coil springs. The both obliquely wound coil springs are in the form of coils formed by winding a wire material made of electrically conductive metal a plurality of times. The female terminal fitting is in the form of a flat plate and a core wire is connected to one end part of the female terminal fitting.

The female terminal fitting is accommodated in the female housing while being sandwiched by the two obliquely wound coil springs. When the female connector is connected to a mating male connector, the first obliquely wound coil spring is sandwiched by a wall surface (contact wall) and the female terminal fitting in the female housing and the second obliquely wound coil spring is sandwiched by the male terminal fitting provided in the male connector and the female terminal fitting. At this time, the second obliquely wound coil spring contacts the female terminal fitting and a terminal connecting portion and the female terminal fitting and the male terminal fitting are electrically connected by resilient restoring forces of the both obliquely wound coil springs. Further, the first obliquely wound coil spring is arranged to press the female terminal fitting toward the core wire.

### PRIOR ART DOCUMENT

### Patent Document

Patent Document 1: JP 2014-241219 A

Patent Document 2: JP 2019-046760 A

### SUMMARY OF THE INVENTION

### Problems to be Solved

In the case of Patent Document 1, a step of crimping the conductor crimping pieces to the conductor is necessary. In the case of Patent Document 2, since the second obliquely wound coil spring is interposed between the male terminal fitting provided in the male connector and the female terminal fitting, the connector tends to be enlarged.

A connector of the present disclosure was completed on the basis of the above situation and aims to enable the omission of a crimping step without enlargement.

### Means to Solve the Problem

The present disclosure is directed to a connector with a conductive member capable of electrically contacting two conductors as connection objects, and a pressing member made of a resilient insulating material, the pressing member applying a pressing force in a contact direction to the conductive member and the two conductors, wherein the pressing member includes a first pressing portion for applying a pressing force to one of the conductors and a second pressing portion for applying a pressing force to the other conductor, and the first and second pressing portions are resiliently deformable independently of each other.

### Effect of the Invention

According to the present disclosure, a crimping step can be omitted without enlargement.

### BRIEF DESCRIPTION OF THE DRAWINGS

FIG. 1 is an exploded perspective view of a female connector of a first embodiment.

FIG. 2 is an exploded perspective view of a male connector.

FIG. 3 is a side view in section of the female connector.

FIG. 4 is a plan view in section of the female connector.

FIG. 5 is a front view showing a state where a front member is removed in the female connector.

FIG. 6 is a side view in section showing a state where a first conductor and a second conductor having different outer diameters are connected.

FIG. 7 is a side view in section showing a state where a first conductor and a second conductor having an equal outer diameter are connected.

FIG. 8 is an exploded perspective view of a pressing member of a second embodiment.

FIG. 9 is a side view in section showing a state where a first conductor and a second conductor are connected.

### DETAILED DESCRIPTION TO EXECUTE THE INVENTION

### Description of Embodiments of Present Disclosure

First, embodiments of the present disclosure are listed and described.

The connector of the present disclosure is provided with a conductive member capable of electrically contacting two conductors as connection objects, and a pressing member made of a resilient insulating material, the pressing member applying a pressing force in a contact direction to the conductive member and the two conductors, wherein the pressing member includes a first pressing portion for applying a pressing force to one of the conductors and a second pressing portion for applying a pressing force to the other conductor, and the first and second pressing portions are resiliently deformable independently of each other.

According to the configuration of the present disclosure, since the conductive member and the conductors are held in contact by the resilient pressing force in the contact direction applied from the pressing member, a step of crimping the conductors and the conductive member is unnecessary. Since the pressing member is made of the insulating material and a structure for insulation needs not be provided separately from the pressing member, the enlargement of the connector can be avoided. Therefore, the connector of the present disclosure can omit a crimping step without being enlarged. Since the first and second pressing portions are resiliently deformable independently of each other, one conductive member can be reliably brought into contact with the two conductors even if an outer diameter of the one conductor receiving the pressing force from the first pressing portion and that of the other conductor receiving the pressing force from the second pressing portion are different.

(2) Preferably, the pressing member includes a coupling portion for coupling the first and second pressing portions. According to this configuration, the first and second pressing portions can be integrally handled.

(3) Preferably, in (2), the coupling portion is integrally connected to the first and second pressing portions and has a smaller cross-sectional area than the first and second pressing portions. According to this configuration, the pressing member can be configured as a single component.

(4) Preferably, in (3), the conductive member is formed of an electrically conductive plate material overlapped on the first pressing portion, the second pressing portion and the coupling portion, and the coupling portion and a part of the conductive member facing the coupling portion are narrower than the first and second pressing portions. According to this configuration, the first and second pressing portions can be resiliently deformed independently of each other and the conductive member can be deformed, following resilient deformation of the first and second pressing portions.

(5) Preferably, in (2), the pressing member includes a first component having the first pressing portion and a second component separate from the first component and having the second pressing portion, the coupling portion is configured by engaging a first engaging portion formed on the first component and a second engaging portion formed on the second component, and the first and second components are relatively displaceably coupled by the coupling portion. According to this configuration, when the first or second pressing portion is resiliently deformed, that resilient deformation does not affect the mating pressing portion.

(6) The connector is provided with the conductive member on a fixed side fixed to a supporting portion, and the conductive member on a movable side configured to be relatively displaced with respect to the supporting portion according to resilient deformation of the pressing member, the conductors being sandwiched between the conductive member on the fixed side and the conductive member on the movable side. According to this configuration, the conductors and the conductive member on the fixed side can be reliably brought into contact without being affected by the resilient deformation of the pressing member.

### Details of Embodiments of Present Disclosure

### First Embodiment

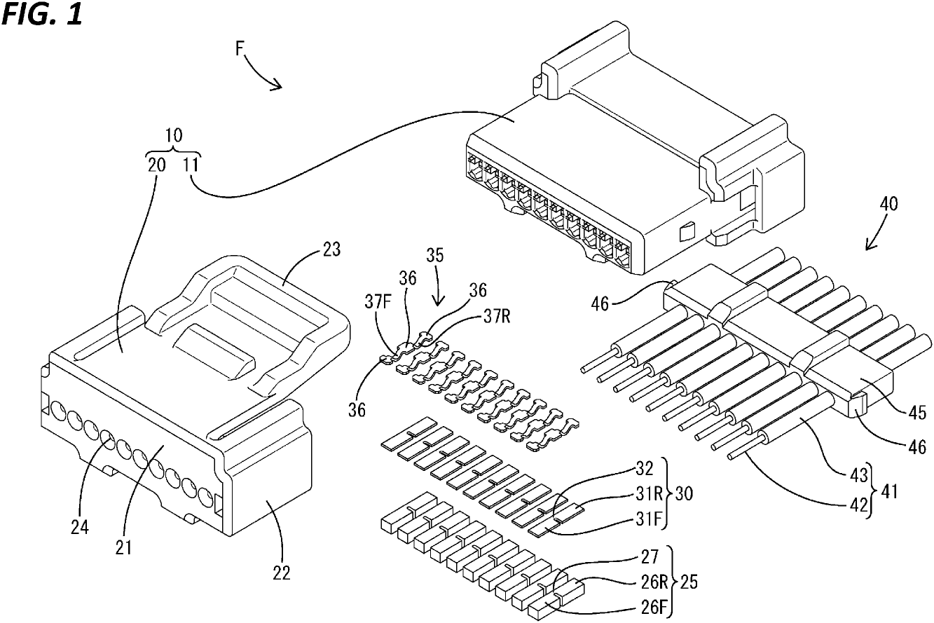

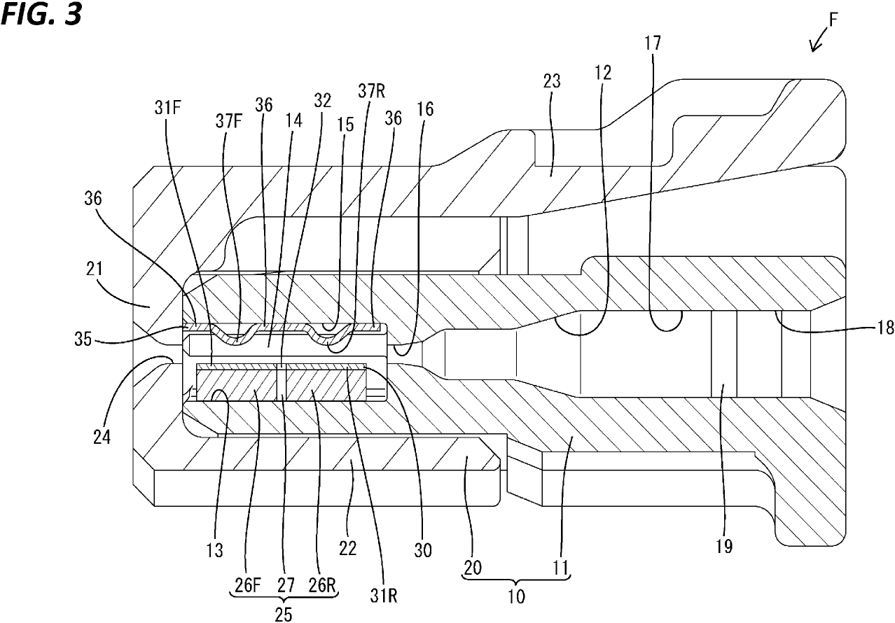

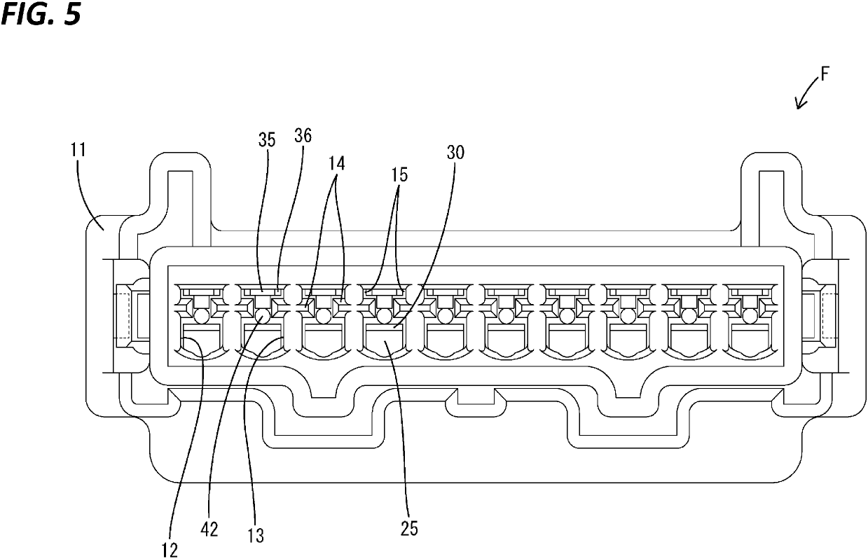

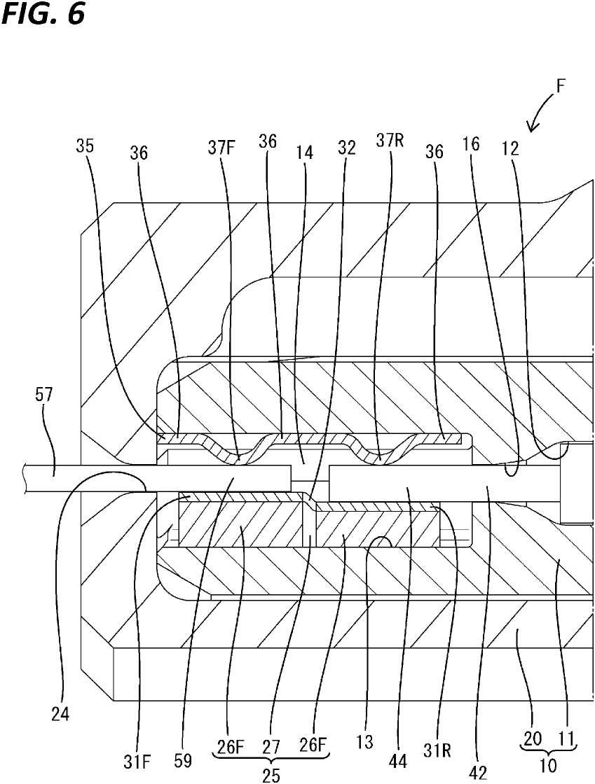

A specific first embodiment of a connector of the present disclosure is described below with reference to FIGS. 1 to 7. Note that the present invention is not limited to these illustrations and is intended to be represented by claims and include all changes in the scope of claims and in the meaning and scope of equivalents. In the first embodiment, a left side in FIGS. 3, 4, 6 and 7 is defined as a front side concerning a front-rear direction. Upper and lower sides shown in FIGS. 1 to 3 and 5 to 7 are directly defined as upper and lower sides concerning a vertical direction. Left and right sides shown in FIG. 5 are directly defined as left and right sides concerning a lateral direction. The lateral direction and a width direction are used as synonyms.

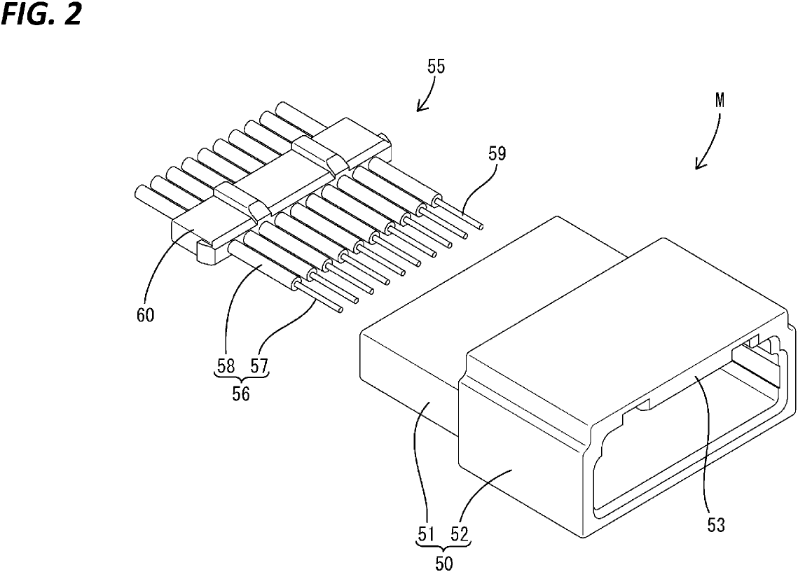

A connector of the first embodiment includes a female connector F and a male connector M to be connected to each other as shown in FIGS. 1 and 2. As shown in FIG. 1, the female connector F includes one female housing 10, a plurality of pressing members 25, a plurality of movable conductive members 30, a plurality of fixed conductive members 35 and one first wire moment 40. The male connector M includes one male housing 50 and one second wire module 55.

The female housing 10 is made of a synthetic resin material and includes, as shown in FIG. 3, a housing body 11 and a front member 20 attached to the housing body 11 from front. The housing body 11 includes a plurality of cavities 12 arranged in parallel in the lateral direction and one holding space 18 open in the rear end surface of the housing body 11. The cavity 12 constitutes a space elongated in the front-rear direction as a whole.

A connecting portion 13 open in the front end surface of the housing body 11 is formed in a front end part of the cavity 12. The connecting portion 13 has a function as a supporting portion for fixing the fixed conductive member 35 to be described later. The inside of the connecting portion 13 functions as a connection space for connecting a first conductor 42 and a second conductor 57 to be described later. As shown in FIG. 5, the connecting portion 13 is formed with a pair of left and right positioning portions 14 for positioning the first and second conductors 42, 57 in the width direction. The pair of positioning portions 14 are formed to project inward in the width direction from both left and right inner wall surfaces of the connecting portion 13. A pair of left and right groove portions 15 extending in the front-rear direction are formed in upper end parts of the inner side surfaces of the connecting portion 13, i.e. in regions above the positioning portions 14.

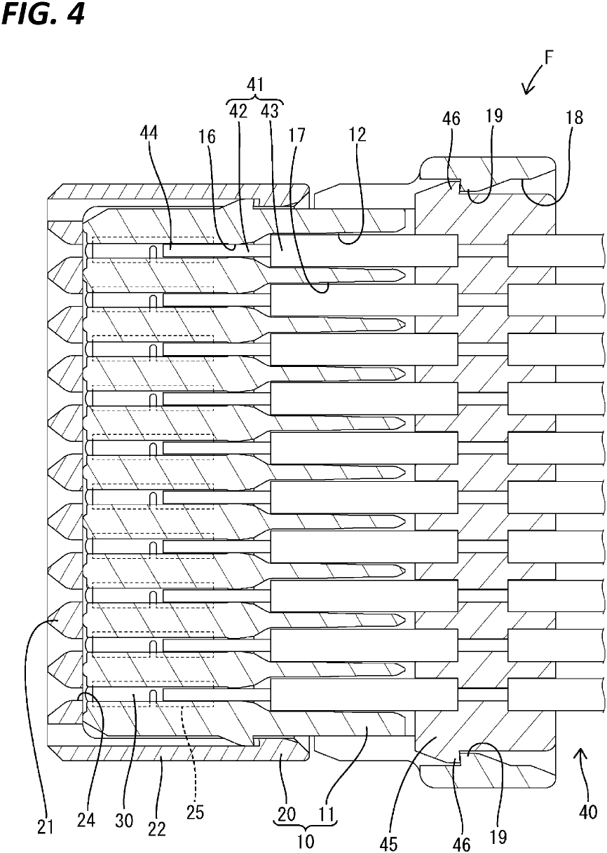

As shown in FIG. 3, a region of the cavity 12 continuous with the rear end of the connecting portion 13 functions as a guide portion 16 including a guide hole having a smaller diameter than the connecting portion 13. A region of the cavity 12 from the rear end of the guide portion 16 to the rear end of the cavity 12 functions as an insertion portion 17 having a larger diameter than the guide portion 16. The holding space 18 is in the form of a slit long in the lateral direction and open in the rear end surface of the housing body 11. As shown in FIG. 4, the holding space 18 communicates with the rear ends of all the plurality of cavities 12 (insertion portions 17). A pair of left and right retaining projections 19 are formed on both left and right end parts of the holding space 18.

The front member 20 is cap-shaped and includes, as shown in FIG. 3, a front wall portion 21 for covering the front surface of the housing body 11, a peripheral wall portion 22 for surrounding a front end side region of the housing body 11 and a lock arm 23 extending rearward from the front wall portion 21 and constituting a part of the peripheral wall portion 22. Openings on the front ends of the plurality of connecting portions 13 are covered by the front wall portion 21. A plurality of insertion holes 24 penetrating through the front wall portion 21 in the front-rear direction are formed at a plurality of positions of the front wall portion 21 corresponding to the respective cavities 12 (connecting portions 13). Each insertion hole 24 has a circular cross-sectional shape having a smaller diameter than the connecting portion 13.

The plurality of pressing members 25 are made of an electrically insulating rubber material and resiliently deformable. The plurality of pressing members 25 are individually accommodated in the plurality of connecting portions 13. The pressing member 25 is arranged while being placed on the bottom surface of the connecting portion 13. As shown in FIGS. 1 and 3, the pressing member 25 is a single component including a first pressing portion 26R, a second pressing portion 26F and a coupling portion 27 and has a rectangular parallelepiped shape long in the front-rear direction as a whole. A maximum width of the pressing member 25 is set larger than an interval between the projecting ends of the pair of positioning portions 14.

The first pressing portion 26R constitutes a rear end side part of the pressing member 25, and the second pressing portion 26F constitutes a front end side part of the pressing member 25. The first and second pressing portions 26R, 26F are front-rear symmetrically shaped. The coupling portion 27 couples the front end of the first pressing portion 26R and the rear end of the second pressing portion 26F. The upper surface of the first pressing portion 26R, that of the coupling portion 27 and that of the second pressing portion 26F are connected at the same height.

One side surface, out of both left and right side surfaces of the pressing member 25, is recessed into a groove in the coupling portion 27. That is, a cross-sectional area of the coupling portion 27 is smaller than those of the first and second pressing portions 26R, 26F when the pressing member 25 is cut perpendicular to the front-rear direction, which is an arrangement direction of the first and second pressing portions 26R, 26F. Accordingly, the coupling portion 27 is more easily resiliently deformed than the first and second pressing portions 26R, 26F. When the first and second pressing portions 26R, 26F are resiliently deformed, a rear end part of the coupling portion 27 follows the first pressing portion 26R and a front end part of the coupling portion 27 follows the second pressing portion 26F, wherefore a movement of the first pressing portion 26R is hardly transmitted to the second pressing portion 26F and a movement of the second pressing portion 26F is hardly transmitted to the first pressing portion 26R.

The movable conductive member 30 is, for example, formed of a plate material made of metal such as copper or aluminum. The movable conductive member 30 has the same shape as the upper surface of the pressing member 25. As shown in FIGS. 1 and 3, the movable conductive member 30 includes a first conductive portion 31R fixed to the upper surface of the first pressing portion 26R, a second conductive portion 31F fixed to the upper surface of the second pressing portion 26F and a coupling conductive portion 32 fixed to the upper surface of the coupling portion 27. As shown in FIG. 3, the movable conductive member 30 and the pressing member 25 are accommodated in a region of the connecting portion 13 below the positioning portions 14. Note that the movable conductive member 30 needs not be fixed in all of the first pressing portion 26R, the second pressing portion 26F and the coupling portion 27, and may be partially fixed.

The movable conductive member 30 has a rectangular shape long in the front-rear direction as a whole. A maximum width of the movable conductive member 30 is set larger than the interval between the projecting ends of the pair of positioning portions 14. One side edge part in the lateral direction of the movable conductive member 30 is cut into a groove, whereby the coupling conductive portion 32 is formed. The first conductive portion 31R is displaced in the vertical direction integrally with an upper surface part of the first pressing portion 26R. The second conductive portion 31F is displaced in the vertical direction integrally with an upper surface part of the second pressing portion 26F. The coupling conductive portion 32 is displaced in the vertical direction integrally with an upper surface part of the coupling portion 27.

The fixed conductive member 35 is, for example, formed of a plate material made of metal such as copper or aluminum, similarly to the movable conductive member 30. As shown in FIGS. 1 and 3, the fixed conductive member 35 is a single component including three mounting portions 36 arranged at intervals in the front-rear direction, a first contact point portion 37R and a second contact point portion 37F located forward of the first contact point portion 37R. The front and rear ends of the first contact point portion 37R are connected to the rear end of the mounting portion 36 located in a middle and the front end of the mounting portion 36 located on a rear side. The front and rear ends of the second contact point portion 37F are connected to the rear end of the mounting portion 36 located on a front side and the front end of the mounting portion 36 located in the middle. In a side view of the fixed conductive member 35, the first and second contact point portions 37R, 37F have a curved shape bulging downward and are shaped to project further downward than the mounting portions 36.

The fixed conductive member 35 is fixed and mounted in an upper end part of the connecting portion 13 by fitting both left and right end parts of the three mounting portions 36 into the groove portions 15 of the connecting portion 13. The fixed conductive member 35 is located above the pressing member 25 and the movable conductive member 30 and is vertically facing the movable conductive member 30 across a predetermined gap. Vertical intervals between the lower ends of the first and second contact point portions 37R, 37F and the upper surface of the movable conductive member 30 in a state where the pressing member 25 is not resiliently deformed are set smaller than outer diameters of the first and second conductors 42, 57 to be described later. Widths of the first and second contact point portions 37R, 37F are set smaller than the interval between the projecting ends of the pair of positioning portions 14. In a front view of the female connector F, the first and second contact point portions 37R, 37F are arranged between the pair of positioning portions 14.

The first wire moment 40 is an integrated assembly of a plurality of first coated wires 41 and one first holding member 45. The first coated wire 41 is such that the first conductor 42 is surrounded by a first insulation coating 43. The first conductor 42 is a single core wire made of a metal material such as copper or aluminum and has such rigidity as to maintain a circular cross-sectional shape. The outer diameter of the first conductor 42 is set smaller than widths of the first and second conductive portions 31R, 31F and smaller than the interval between the projecting ends of the pair of positioning portions 14. In an end part of the first coated wire 41, the first insulation coating 43 is removed to expose the first conductor 42. An exposed part of the first conductor 42 is defined as a first connecting end portion 44.

As shown in FIG. 1, the first holding member 45 has a flat shape in the width direction and collectively holds intermediate stripped parts of the plurality of first coated wires 41 laterally arranged side by side. The first holding member 45 is a molded article formed of resin to cover around the plurality of first coated wires 41. The plurality of first coated wires 41 penetrate through the first holding member 45 in the front-rear direction and are held while being positioned at certain intervals in the lateral direction. A pair of left and right locking projections 46 are formed on both left and right side surfaces of the first holding member 45.

The first wire moment 40 is mounted into the housing body 11 from behind the female housing 10. With the first wire moment 40 mounted in the female housing 10, the locking projections 46 of the first holding member 45 are locked to the retaining projections 19 of the female housing 10, whereby the first wire moment 40 is retained and held in the female housing 10.

In an assembling process, the first connecting end portions 44 of the plurality of first conductors 42 are successively passed through the insertion portions 17 and the guide portions 16, enter the connecting portions 13 and are squeezed and sandwiched between the first conductive portions 31R and the first contact point portions 37R. In the state where the pressing member 25 is not resiliently deformed, an interval between the first conductive portion 31R and the first contact point portion 37R is smaller than an outer diameter of the first connecting end portion 44. Thus, the first conductive portion 31R is displaced downward while resiliently deforming and squeezing the first pressing portion 26R. By a resilient restoring force of the first pressing portion 26R, the first conductor 42 and the first conductive portion 31R are conductively connected with a predetermined contact pressure and the first conductor 42 and the first contact point portion 37R are conductively connected with a predetermined contact pressure.

With the first conductor 42 sandwiched between the first conductive portion 31R and the first contact point portion 37R, the first pressing portion 26R is resiliently deformed to be vertically squeezed. However, since the coupling portion 27 is interposed between the first and second pressing portions 26R, 26F, the resilient deformation of the first pressing portion 26R does not affect the second pressing portion 26F. Further, although the first conductive portion 31R is displaced downward integrally with the first pressing portion 26R, the coupling conductive portion 32 having a small width and more easily deformable than the first and second conductive portions 31R, 31F is interposed between the first and second conductive portions 31R, 31F. In addition, the second pressing portion 26F resiliently presses the second conductive portion 31F upward. In this way, the coupling conductive portion 32 is bent and deformed and the second conductive portion 31F is held substantially at the same height as that when the first conductor 42 is not sandwiched between the first conductive portion 31R and the first contact point portion 37R.

The male housing 50 constituting the male connector M is made of synthetic resin and, as shown in FIG. 2, a single component including a housing portion 51 and a tubular receptacle 52 projecting from the housing portion 51. A lock portion 53 to be locked to the lock arm 23 of the female connector F is provided on the inner surface of an upper wall part of the receptacle 52. Although not shown, the housing portion 51 includes a plurality of guide portions 16, a plurality of insertion portions 17 and a holding space 18 similar to the plurality of guide portions 16, the plurality of insertion portions 17 and the holding space 18 of the female connector F. The housing portion 51 does not have parts equivalent to the connecting portions 13 of the female connector F.

The second wire module 55 is an integrated assembly of a plurality of second coated wires 56 and one second holding member, similarly to the first wire moment 40. Similarly to the first coated wire 41, the second coated wire 56 is configured such that the second conductor 57 is surrounded by a second insulation coating 58. The second conductor 57 is a single core wire made of a metal material such as copper or aluminum and has such rigidity as to maintain a circular cross-sectional shape.

The outer diameter of the second conductor 57 is set smaller than the widths of the first and second conductive portions 31R, 31F, smaller than the interval between the projecting ends of the pair of positioning portions 14 and smaller than the outer diameter of the first conductor 42. In an end part of the second coated wire 56, the first insulation coating 43 is removed to expose the second conductor 57. An exposed part of the second conductor 57 is defined as a second connecting end portion 59. The second holding member 60 has the same shape as the first holding member 45 and is integrated with the second coated wires 56 by having the same configuration as the first holding member 45.

The second wire module 55 is also mounted into the housing portion 51 by having a configuration similar to that of the first wire moment 40. With the second wire module 55 mounted in the male housing 50, the second connecting end portions 59 of the second conductors 57 project into the receptacle 52 from the front surface of the housing portion 51.

In connecting the male connector M and the female connector F, the female connector F is fit into the receptacle 52. In a connection process, the second connecting end portions 59 of the second conductors 57 are passed through the insertion holes 24, enter the connecting portions 13 and are inserted between the second conductive portions 31F and the second contact point portions 37F. At this point of time, the first conductor 42 is sandwiched between the first conductive portion 31R and the first contact point portion 37R, but the coupling conductive portion 32 is bent and deformed and the coupling portion 27 is resiliently deformed due to rigidity acting on the second conductive portion 31F from the second pressing portion 26F. Therefore, the interval between the second conductive portion 31F and the second contact point portion 37F is kept smaller than the outer diameter of the second conductor 57. In this way, the second conductive portion 31F is displaced downward while resiliently deforming and squeezing the second pressing portion 26F.

Since the outer diameter of the second conductor 57 is smaller than that of the first conductor 42, there is a height difference between the first conductive portion 31R and the second conductive portion 31F and a vertical resilient deformation amount of the second pressing portion 26F is smaller than that of the first pressing portion 26R. Since the coupling portion 27 linking the first and second pressing portions 26R, 26F has a lower rigidity than the first and second pressing portions 26R, 26F, the resilient deformation of the first pressing portion 26R hardly affects the second pressing portion 26F. Therefore, the second pressing portion 26F can apply a pressing force toward the second conductor 57.

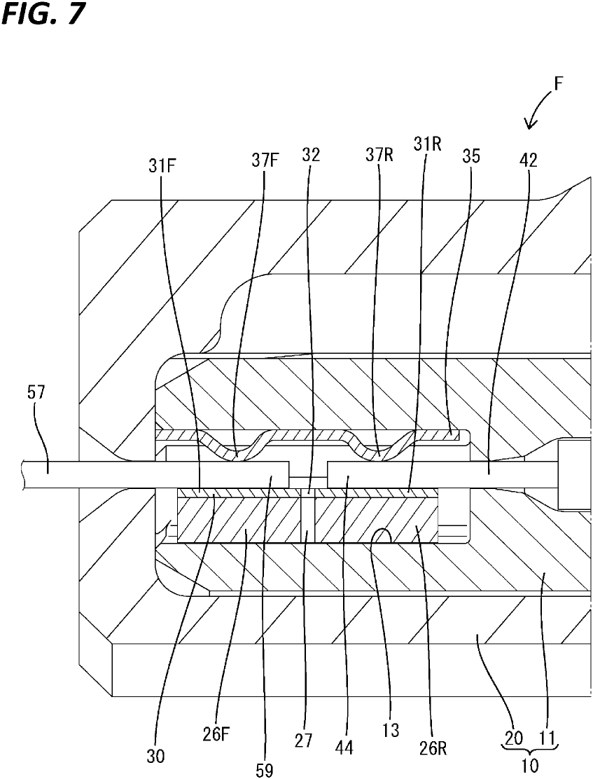

If the outer diameter of the first conductor 42 and that of the second conductor 57 are equal, the resilient deformation amount of the first pressing portion 26R and that of the second pressing portion 26F are the same as shown in FIG. 7. Therefore, the coupling conductive portion 32 is not deformed and the first conductive portion 31R, the second conductive portion 31F and the coupling conductive portion 32 constitute one flat surface at the same height.

The male connector M constituting the connector of the first embodiment includes the female housing 10 into which the first conductors 42 and the second conductors 57 are inserted. The movable conductive members 30 and the fixed conductive members 35 configured to electrically contact the first and second conductors 42, 57 as connection objects are accommodated in the female housing 10. The male connector M includes the pressing members 25 made of the resilient insulating material. The pressing member 25 applies a pressing force in a contact direction to the movable conductive member 30, the fixed conductive member 35 and the first and second conductors 42, 57 inserted into the female housing 10. The pressing member 25 includes the first pressing portion 26R for applying a pressing force to the first conductor 42 and the second pressing portion 26F for applying a pressing force to the second conductor 57. The first and second pressing portions 26R, 26F are resiliently deformable independently of each other.

According to this configuration, the movable conductive member 30 and the fixed conductive member 35 contact the first and second conductors 42, 57 by the resilient pressing force in the contact direction applied from the pressing member 25. Thus, a step of crimping the movable conductive member 30 and the fixed conductive member 35 to the first conductor 42 and a step of crimping the movable conductor and the fixed conductive member 35 to the second conductor 57 are unnecessary. Since the pressing member 25 is made of the insulating material and a structure for insulation needs not be provided separately from the pressing member 25, the enlargement of the female connector F can be avoided.

The connector of the first embodiment can omit the crimping step without being enlarged. Since the first and second pressing portions 26R, 26F are resiliently deformed independently of each other, one conductive member can be reliably brought into contact with the first and second conductors 42, 57 even if the outer diameter of the first conductor 42 receiving the pressing force from the first pressing portion 26R and that of the second conductor 57 receiving the pressing force from the second pressing portion 26F are different.

Since the pressing member 25 includes the coupling portion 27 coupling the first and second pressing portions 26R, 26F, the first and second pressing portions 26R, 26F can be integrally handled. Since the coupling portion 27 is integrally connected to the first and second pressing portions 26R, 26F and has a smaller cross-sectional area than the first and second pressing portions 26R, 26F, the pressing portion 25 configured as a single component could be realized.

The movable conductive member 30 is made of the electrically conductive plate material overlapped on the first pressing portion 26R, the second pressing portion 26F and the coupling portion 27. The coupling portion 27 and a part of the movable conductive member 30 facing the coupling portion 27 (coupling conductive portion 32) are narrower than the first and second pressing portions 26R, 26F. According to this configuration, the first and second pressing portions 26R, 26F can be resiliently deformed independently of each other, and the movable conductive member 30 can be deformed, following the resilient deformation of the first and second pressing portions 26R, 26F.

The connector includes the fixed conductive member 35 fixed to the connecting portion 13 of the female housing 10 and the movable conductive member 30 configured to be relatively displaced with respect to the connecting portion 13 according to the resilient deformation of the pressing member 25. The first and second conductors 42, 57 are sandwiched between the fixed conductive member 35 and the movable conductive member 30. According to this configuration, the first conductor 42 and the fixed conductive member 35 can be reliably brought into contact and the second conductor 57 and the fixed conductive member 35 can be reliably brought into contact without being affected by the resilient deformation of the pressing member 25.

### Second Embodiment

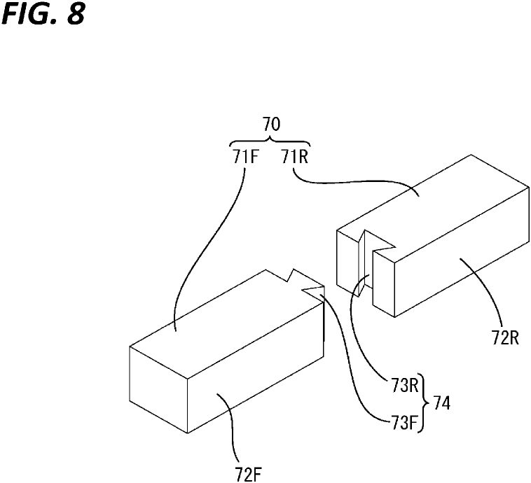

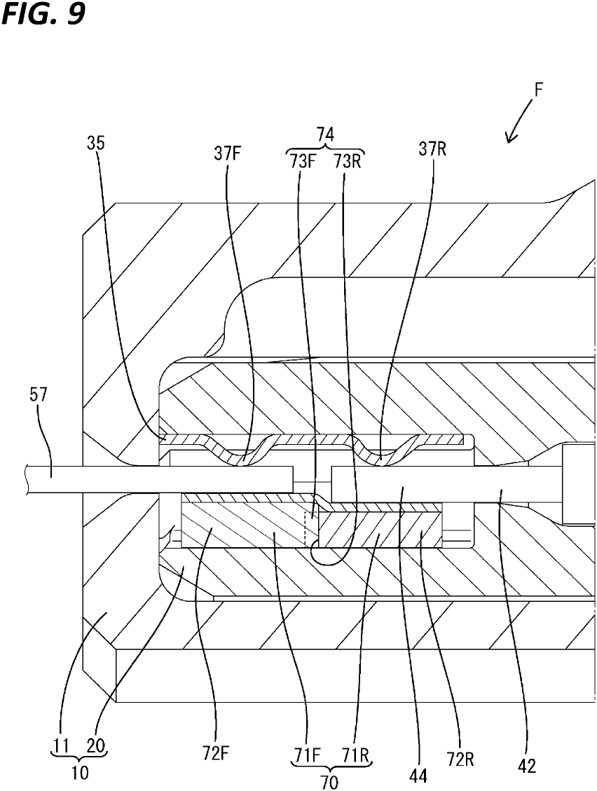

A specific second embodiment of the connector of the present disclosure is described below with reference to FIGS. 8 and 9. The connector of the second embodiment differs from the first embodiment in the configuration of a coupling portion 74 for coupling a first pressing portion 72R and a second pressing portion 72F in a pressing member 70. Since the other configuration is the same as in the first embodiment, the same components are denoted by the same reference signs and the structures, functions and effects thereof are not described.

The pressing member 70 of the second embodiment is configured by assembling a first component 71R and a second component 71F separate from the first component 71R. The first component 71R is a single component including the first pressing portion 72R and a first engaging portion 73R and has a rectangular parallelepiped shape as a whole. The first engaging portion 73R is formed by recessing the front end surface of the first component 71R and in the form of a vertical groove open in the upper and lower surfaces of the first component 71R. In a plan view of the pressing member 70, the first engaging portion 73R has a trapezoidal shape having a width increasing from a front end toward a rear end. A most part of the first component 71R behind the first engaging portion 73R functions as the first pressing portion 72R.

The second component 71F is a single component including the second pressing portion 72F and a second engaging portion 73F and has a rectangular parallelepiped shape as a whole. The second engaging portion 73F is in the form of a rib projecting from the rear end surface of the second component 71F and extending in the vertical direction. In a plan view, the second engaging portion 73F has a trapezoidal shape having a width increasing from a front end toward a rear end, similarly to the first engaging portion 73R. A most part of the second component 71F in front of the second engaging portion 73F functions as the second pressing portion 72F.

The first engaging portion 73R and the second engaging portion 73F constitute the coupling portion 74 for coupling the first and second pressing portions 72R, 72F. The first and second components 71R, 71F are restricted from being relatively displaced in the front-rear direction and lateral direction and, on the other hand, coupled to be relatively displaceable in the vertical direction (resilient deforming direction of the first and second pressing portions 72R, 72F) by the engagement of the first and second engaging portions 73R, 73F. Therefore, the resilient deformation of the first pressing portion 72R does not affect the second pressing portion 72F when the first pressing portion 72R is resiliently deformed. The resilient deformation of the second pressing portion 72F does not affect the first pressing portion 72R when the second pressing portion 72F is resiliently deformed.

### Other Embodiments

The present invention is not limited to the above described and illustrated embodiments and is represented by claims. The present invention is intended to include all changes in the scope of claims and in the meaning and scope of equivalents and also include the following embodiments.

Although the first and second pressing portions are coupled by the coupling portion in the above first and second embodiments, the first and second pressing portions may not be coupled.

Although the movable conductive member is a plate-like member made of metal such as copper or aluminum in the above first and second embodiments, the movable conductive member may be a linear member or rod-like member made of metal or may be an electrically conductive member formed of a metal foil of copper, aluminum or the like, carbon powder, carbon nanotubes or the like and to be applied to the pressing member.

Although the pressing member is made of rubber in the above first and second embodiments, the pressing member is not limited to the one made of rubber and may be made of synthetic resin.

Although the first and second conductors are the single core wires of the wires in the above first and second embodiments, the first and second conductors are not limited to the core wires and may be formed by solidifying stranded wires by ultrasonic welding, laser welding or the like or may be busbars made of a metal plate material.

In the above first and second embodiments, at least one of the first conductive portion and the second conductive portion on the movable side may be formed with a projection-like contact point portion.

In the above first and second embodiments, a plurality of movable conductive members may be integrated with one first pressing portion.

In the above first and second embodiments, a plurality of movable conductive members may be integrated via a coupling portion.

In the above first and second embodiments, a plurality of fixed conductive members may be integrated via a coupling portion.

Although the movable conductive member and the fixed conductive member are brought into contact with the conductors in the above first and second embodiments, the fixed conductive member may not be provided and only the movable conductive member may be brought into contact with the conductors or the movable conductive member may not be provided and only the fixed conductive member may be brought into contact with the conductors.

In the above first and second embodiments, the pressing member and the movable conductive member may be provided instead of the fixed conductive member, and a pair of the movable conductive members may be resiliently brought into contact with the two conductors by resilient forces of a pair of the pressing members.

### List of Reference Numerals

F ... female connector
M ... male connector
10 ... female housing
11 ... housing body
12 ... cavity
13 ... connecting portion (supporting portion)
14 ... positioning portion
15 ... groove portion
16 ... guide portion
17 ... insertion portion
18 ... holding space
19 ... retaining projection
20 ... front member
21 ... front wall portion
22 ... peripheral wall portion
23 ... lock arm
24 ... insertion hole
25 ... pressing member
26F ... second pressing portion
26R ... first pressing portion
27 ... coupling portion
30 ... movable conductive member (conductive member, conductive member on movable side)
31F ... second conductive portion
31R ... first conductive portion
32 ... coupling conductive portion
35 ... fixed conductive member (conductive member, conductive member on fixed side)
36 ... mounting portion
37F ... second contact point portion
37R ... first contact point portion
40 ... first wire moment
41 ... first coated wire
42 ... first conductor (one conductor)
43 ... first insulation coating
44 ... first connecting end portion
45 ... first holding member
46 ... locking projection
50 ... male housing
51 ... housing portion
52 ... receptacle
53 ... lock portion
55 ... second wire module
56 ... second coated wire
57 ... second conductor (other conductor)
58 ... second insulation coating
59 ... second connecting end portion
60 ... second holding member
70 ... pressing member
71F ... second component
71R ... first conductor
72F ... second pressing portion
72R ... first pressing portion
73F ... second engaging portion
73R ... first engaging portion
74 ... coupling portion

1. A connector, comprising:
a conductive member capable of electrically contacting two conductors as connection objects; and
a pressing member made of a resilient insulating material, the pressing member applying a pressing force in a contact direction to the conductive member and the two conductors, wherein:
the pressing member includes a first pressing portion for applying a pressing force to one of the conductors and a second pressing portion for applying a pressing force to the other conductor, and
the first and second pressing portions are resiliently deformable independently of each other.

2. The connector of claim 1, wherein the pressing member includes a coupling portion for coupling the first and second pressing portions.

3. The connector of claim 2, wherein the coupling portion is integrally connected to the first and second pressing portions and has a smaller cross-sectional area than the first and second pressing portions.

4. The connector of claim 3, wherein:
the conductive member is formed of an electrically conductive plate material overlapped on the first pressing portion, the second pressing portion and the coupling portion, and
the coupling portion and a part of the conductive member facing the coupling portion are narrower than the first and second pressing portions.

5. The connector of claim 2, wherein:
the pressing member includes a first component having the first pressing portion and a second component separate from the first component and having the second pressing portion,
the coupling portion is configured by engaging a first engaging portion formed on the first component and a second engaging portion formed on the second component, and
the first and second components are relatively displaceably coupled by the coupling portion.

6. The connector of claim 1 , comprising:
the conductive member on a fixed side fixed to a supporting portion; and
the conductive member on a movable side configured to be relatively displaced with respect to the supporting portion according to resilient deformation of the pressing member,
the conductors being sandwiched between the conductive member on the fixed side and the conductive member on the movable side.
